(19) United States
(12) Patent Application Publication
(10) Pub. No.: US 2026/0291089 A1
(43) Pub. Date: Sep. 24, 2026

(54) TERMINAL BLOCK HOUSING AND POWER TERMINAL FOR POWER CONNECTOR

(71) Applicant: TE Connectivity Solutions GmbH, Schaffhausen (CH)

(72) Inventor: Brian Keith Weaver, Harrisburg, PA (US)

(21) Appl. No.: 19/084,912

(22) Filed: Mar. 20, 2025

(51) Int. Cl. H01R 9/24; H01R 9/22

(52) U.S. Cl. CPC H01R 9/2416; H01R 9/223

(57) ABSTRACT

A power connector includes a terminal block housing having a terminal cavity with a load opening at the rear and an access opening at the top. A power terminal assembly is received in the terminal cavity through the load opening. The power terminal assembly includes a power terminal with a screw threadably coupled to a nut through a head of the power terminal. A terminal retainer is coupled to the rear of the terminal block housing to close the terminal cavity at the rear and retain the power terminal assembly in the terminal cavity.

### BACKGROUND OF THE INVENTION

The subject matter herein relates generally to power connectors.

Electrical appliances commonly utilize power connectors to establish an electrical connection between the appliance and an external power source. A typical configuration includes a terminal block housing that holds a set of power terminals, which are designed to mate with ring terminals fixed to power supply wires. This connection scheme is prevalent in various household and industrial appliances, such as ovens, dryers, and other high-power equipment.

Conventional power connectors of this type often suffer from several drawbacks. One significant issue is the complexity of assembly. During installation, the power terminals are typically loaded into the terminal block housing through an opening in the top of the terminal block housing and then the power terminals are slid rearward to locked positions. Such assembly is complicated and leads to a large size of the power terminals and the terminal block housing to accommodate the components needed for assembly and fixturing.

Another problem associated with conventional power connectors is their overall size. The terminal block housing, along with the power terminals and fastening components, often results in a bulky configuration. This increased size not only limits design flexibility but also occupies valuable internal space within the appliance, potentially interfering with other components or reducing the overall compactness of the appliance design.

There is a need for improved power connector for appliances that addresses the issues of complicated assembly and large overall size. An improved design would simplify the assembly process and reduce the size of the connector assembly by maintaining a reliable and secure electrical connection throughout the appliance operational lifespan.

### BRIEF DESCRIPTION OF THE INVENTION

In one embodiment, a power connector is provided and includes a terminal block housing that includes a terminal cavity. The terminal block housing includes a top and a bottom extending between a front and a rear of the terminal block housing. The terminal block housing includes a first side and a second side between the top and the bottom. The terminal block housing includes a load opening at the rear and an access opening at the top. The power connector includes a power terminal assembly received in the terminal cavity. The power terminal assembly includes a power terminal includes a head and a tail. The tail configured to be coupled to a power wire. The head includes an opening. The power terminal assembly includes a screw received in the opening and a nut coupled to a threaded end of the screw configured to be coupled to a ring terminal of a power supply. The head captured between a screw head of the screw and the nut. The power connector includes a terminal retainer coupled to the rear of the terminal block housing to close the terminal cavity at the rear. The power terminal assembly is rear loaded into the terminal cavity through the load opening. The terminal retainer retains the power terminal assembly in the terminal cavity. The screw head of the screw of the power terminal assembly is accessible through the access opening at the top of the terminal block housing.

In another embodiment, a power connector is provided and includes a terminal block housing that includes a terminal cavity. The terminal block housing includes a top and a bottom extending between a front and a rear of the terminal block housing. The terminal block housing includes a first side and a second side between the top and the bottom. The terminal block housing includes a load opening at the rear and an access opening at the top. The terminal block housing includes retention elements extending into the terminal cavity. The power connector includes a power terminal assembly received in the terminal cavity. The power terminal assembly includes a power terminal includes a head and a tail. The tail is configured to be coupled to a power wire. The head includes a front edge, a rear edge, a first side edge between the front and rear edges, and a second side edge between the front and rear edges. The head includes an opening therethrough. The power terminal assembly includes a screw received in the opening and a nut coupled to a threaded end of the screw configured to be coupled to a ring terminal of a power supply. The head is captured between a screw head of the screw and the nut. The screw head of the screw of the power terminal assembly is accessible through the access opening at the top of the terminal block housing. The power connector includes a terminal retainer coupled to the rear of the terminal block housing to close the terminal cavity at the rear. The power terminal assembly is rear loaded into the terminal cavity through the load opening. The terminal retainer engages the rear edge to retain the power terminal assembly in the terminal cavity and block removal of the power terminal assembly through the load opening. The retention elements engage the first and second side edges to retain the power terminal assembly in the terminal cavity and block removal of the power terminal assembly through the access opening.

In a further embodiment, a terminal block housing for a power terminal assembly includes a power terminal which includes a head holding a screw and a nut configured to be coupled to a ring terminal of a power supply is provided. The terminal block housing includes housing walls forming a terminal cavity. The housing walls extend between a top and a bottom of the terminal block housing. The housing walls extend between a front and a rear of the terminal block housing. The housing walls extend between a first side and a second side of the terminal block housing. The terminal block housing includes a load opening at the rear providing access to the terminal cavity. The power terminal assembly is configured to be loaded into the terminal cavity through the load opening. The terminal block housing includes an access opening at the top providing access to the power terminal assembly. The terminal block housing includes retention elements extending into the terminal cavity. The retention elements are configured to engage the head to retain the power terminal assembly in the terminal cavity and block removal of the power terminal assembly through the access opening. The terminal block housing includes a terminal retainer coupled to the rear of the terminal block housing at the load opening to close the terminal cavity at the rear. The terminal retainer configured to engage the head to retain the power terminal assembly in the terminal cavity and block removal of the power terminal assembly through the load opening.

### BRIEF DESCRIPTION OF THE DRAWINGS

FIG. 1 is a perspective view of a power connector in accordance with an exemplary embodiment.

FIG. 2 is a perspective view of the power terminal assembly in accordance with an exemplary embodiment.

FIG. 3 is a perspective view of the terminal block housing in accordance with an exemplary embodiment.

FIG. 4 is a partially assembled view of the power connector in accordance with an exemplary embodiment.

FIG. 5 is a rear perspective view of a portion of the power connector in accordance with an exemplary embodiment showing one of the power terminal assemblies loaded into the terminal block housing.

FIG. 6 is a top perspective view of a portion of the power connector in accordance with an exemplary embodiment showing one of the power terminal assemblies loaded into the terminal block housing.

### DETAILED DESCRIPTION OF THE INVENTION

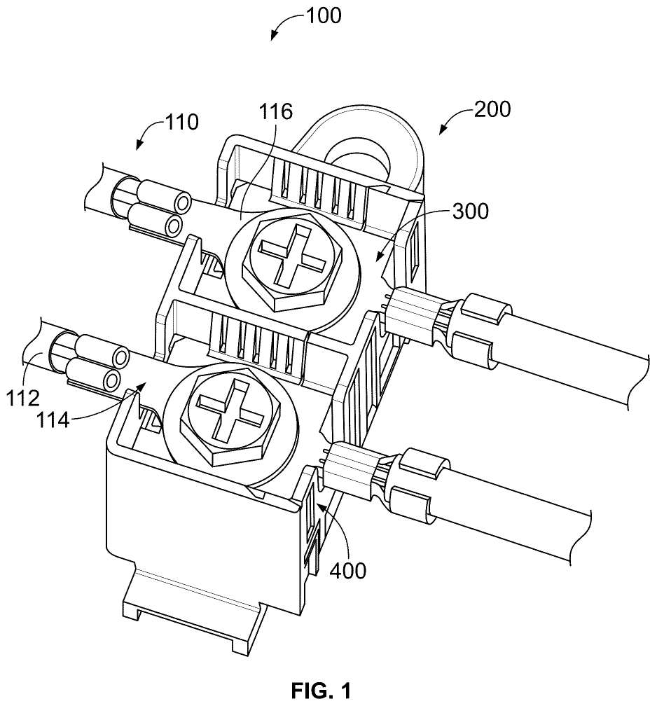

FIG. 1 is a perspective view of a power connector 100 in accordance with an exemplary embodiment. The power connector 100 is configured to be electrically connected to one or more power supplies 110. In the illustrated embodiment, the power connector 100 is electrically connected to two power supplies 110. In an exemplary embodiment, each power supply 110 includes a power supply wire 112 and a power supply terminal 114 at the end of the power supply wire 112. In the illustrated embodiment, the power supply terminal 114 includes a ring terminal 116. Other types of terminals may be used in alternative embodiments. In alternative embodiments, the power supply 110 includes a busbar.

In an exemplary embodiment, the power connector 100 includes a terminal block housing 200, one or more power terminal assemblies 300 held by the terminal block housing 200, and a terminal retainer 400 configured to hold the power terminal assemblies 300 in the terminal block housing 200. In the illustrated embodiment, the power connector 100 includes two of the power terminal assemblies 300. Greater or fewer power terminal assemblies 300 may be provided in alternative embodiments. In an exemplary embodiment, the terminal retainer 400 is configured to be opened and closed to provide access to the terminal block housing 200 for loading/unloading of the power terminal assemblies 300 into the terminal block housing 200. In an exemplary embodiment, the power terminal assemblies 300 are configured to be rear loaded into the terminal block housing 200 and are accessible from above, such as for connection to the power supply terminals 114. In an exemplary embodiment, the power terminal assemblies 300 have short profiles (short front-to-rear) allowing the use of a narrow terminal block housing 200, thus reducing the overall size of the power connector 100 and providing a material cost savings.

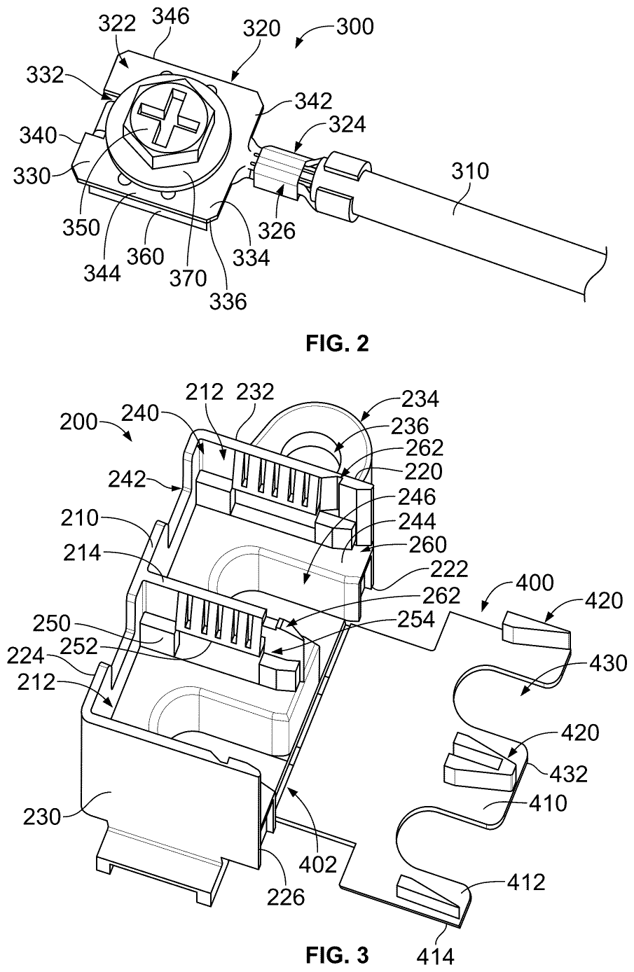

FIG. 2 is a perspective view of the power terminal assembly 300 in accordance with an exemplary embodiment. The power terminal assembly 300 includes a power wire 310 and a power terminal 320 terminated to the end of the power wire 310. For example, the power terminal 320 may be crimped, soldered or welded to the conductor at the end of the power wire 310. In alternative embodiments, the power terminal assembly 300 may include a busbar rather than the power wire 310. In an exemplary embodiment, the power terminal assembly 300 includes a screw 350, a nut 360, and a washer 370 coupled to the power terminal 320 and configured to electrically connect the power terminal assembly 300 to the power supply terminal 114 (shown in FIG. 1). The screw 350 is configured to be threadably coupled to the nut 360 and tightened to electrically connect the power terminal 320 to the power supply terminal 114.

The power terminal 320 includes a head 322 and a tail 324 extending from the head 322. The tail 324 is configured to be coupled to the power wire 310. For example, the tail 324 includes a crimp barrel 326 configured to be crimped to the power wire 310. Other types of terminations may be used in alternative embodiments, such as a solder pad, a weld pad, an insulation displacement contact, and the like. In an exemplary embodiment, the tail 324 is integral with the head 322. For example, the 322 and the tail 324 may be stamped and formed from a metal sheet to form the power terminal 320. The power terminal 320 may be arranged on strip with other power terminals 320, such as being a stamped strip of sheet metal. When the power terminal 320 is assembled, the screw 350, the nut 360, and the washer 370 are coupled to the head 322. The head 322 is configured to be electrically connected to the power supply terminal 114.

In an exemplary embodiment, the head 322 includes a plate 330 having an opening 332 therethrough. The screw 350 passes through the opening 332. The plate 330 includes an upper surface 334 and a lower surface 336. The nut 360 is located at the lower surface 336 and may be coupled to the plate 330 at the lower surface 336. The ring terminal 116 may be coupled to the plate 330 at the lower surface 336. The washer 370 is located at the upper surface 334 and may be coupled to the plate 330 at the upper surface 334. The ring terminal 116 may be coupled to the plate 330 at the upper surface 334. The screw 350 is tightened to capture the ring terminal 116 between the washer 370 and the plate 330 or between the nut 360 and the plate 330.

In an exemplary embodiment, the plate 330 is rectangular. However, the plate 330 may have other shapes in alternative embodiments. In an exemplary embodiment, the plate 330 includes a front edge 340, a rear edge 342, a first side edge 344, and a second side edge 346. The plate 330 may include additional edges if having a different shape. In an exemplary embodiment, the opening 332 may be open at one of the edges such as the front edge 340, to receive the screw 350. The tail 324 extends from the rear edge 342 of the plate 330. The first and second side edges 344, 346 extend between the front and rear edges 340, 342. The first and second side edges 344, 346 may be perpendicular to the front and rear edges 340, 342. The first and second side edges 344, 346 may be parallel to each other. The front and rear edges 340, 342 may be parallel to each other. The plate 330 has a width between the first and second side edges 344, 346 and a length between the front edge 340 and the rear edge 342. In an exemplary embodiment, the plate 330 is relatively short. For example, the width may be greater than or equal to the length. The short profile of the plate 330 (for example, short front-to-rear) allows the use of a small (for example, short) terminal block housing 200, thus reducing the overall size of the power connector 100 and providing a material cost savings.

FIG. 3 is a perspective view of the terminal block housing 200 in accordance with an exemplary embodiment. The terminal block housing 200 includes walls 210 forming one or more terminal cavities 212 configured to receive the corresponding power terminal assemblies 300 (shown in FIG. 2). In the illustrated embodiment, the terminal block housing 200 includes two of the terminal cavities 212 with a separating wall 214 of the walls 210 therebetween. Greater or fewer terminal cavities 212 may be provided in alternative embodiments.

In an exemplary embodiment, the terminal block housing 200 is manufactured from a dielectric material, such as a plastic material. The terminal block housing 200 may be an injection molded part. The terminal block housing 200 extends between a top 220 and the bottom 222. The terminal block housing 200 extends between a front 224 and the rear 226. The terminal block housing 200 includes a first side 230 and a second side 232 opposite the first side 230. The first and second sides 230, 232 extend between the top 220 and the bottom 222 and/or extend between the front 224 and the rear 226. In the illustrated embodiment, the terminal block housing 200 is generally rectangular or box shaped. The terminal block housing 200 may have other shapes in alternative embodiments.

In an exemplary embodiment, the terminal block housing 200 includes a mounting bracket 234 extending from the first side 230 and/or the second side 232. The mounting bracket 234 is used to mount the terminal block housing 200 to another structure. For example, the mounting bracket 234 may include an opening 236 configured to receive a fastener used to secure the terminal block housing 200 to the mounting structure. Other types of mounting features may be provided in alternative embodiments. The mounting bracket 234 may be located proximate to the bottom 222 to mount the bottom 222 to the mounting structure. Other locations are possible in alternative embodiments.

In an exemplary embodiment, the terminal block housing 200 includes an access opening 240 at the top 220. The access opening 240 provides access to the terminal cavity 212. For example, the access opening 240 provides access to the power terminal assembly 300 through the top 220, such as for tightening or loosening the screw 350 and/or for loading the ring terminal 116 of the power supply terminal 114 (shown in FIG. 1) into the terminal cavity 212 for mating with the power terminal assembly 300. In an exemplary embodiment, each terminal cavity 212 includes the corresponding access opening 240.

In an exemplary embodiment, the terminal block housing 200 includes a power supply window 242 through one of the walls 210, such as the wall at the front 224. The power supply window 242 is open to the terminal cavity 212. The power supply window 242 is configured to receive the ring terminal 116 and/or the power supply wire 112 therethrough.

In an exemplary embodiment, the walls 210 of the terminal block housing 200 include a support wall 244. The support wall 244 may support one or more components of the power terminal assembly 300. For example, the support wall 244 may support the nut 360. The support wall 244 may be located remote from the top 220 and/or remote from the bottom 222. For example, the support wall 244 may be approximately centered between the top 220 and the bottom 222. In an exemplary embodiment, the support wall 244 includes a pocket 246 configured to receive a portion of the power terminal assembly 300, such as the screw 350. The pocket 246 is open from above to receive the screw 350. The pocket 246 may be open at other sides, such as the rear 226.

In an exemplary embodiment, the terminal block housing 200 includes one or more retainer elements 250 extending into the terminal cavity 212. The retainer elements 250 are configured to engage the power terminal assembly 300, such as the head 322 of the power terminal 320. The retainer elements 250 are used to retain the power terminal assembly 300 in the terminal cavity 212. For example, the retainer elements 250 may block removal of the power terminal assembly 300 through the access opening 240. The retainer elements 250 may block upward movement of the power terminal assembly 300. For example, the retainer elements 250 may interface with the upper surface of the plate 330 of the power terminal 320. In the illustrated embodiment, the retainer elements 250 are provided at the opposite sides of the terminal cavity 212. Other locations are possible in alternative embodiments. In an exemplary embodiment, bottom surfaces 252 of the retainer elements 250 are configured to interface with the power terminals 320. In an exemplary embodiment, slots 254 are formed between the bottom surfaces 252 of the retainer elements 250 and the support wall 244. The slots 254 are configured to receive the corresponding power terminal assemblies 300. For example, the plates 330 of the power terminals 320 may be received in the corresponding slots 254. In an exemplary embodiment, the power terminal assemblies 300 are rear loaded into the slots 254 through the rear 226 of the terminal block housing 200.

In an exemplary embodiment, the terminal block housing 200 includes load openings 260 at the rear 226. The load openings 260 are configured to receive the corresponding power terminal assemblies 300. For example, the power terminal assemblies 300 are rear loaded into the terminal cavities 212 through the load openings 260 at the rear 226. The power terminal assemblies 300 are loaded in a forward loading direction. The power terminal assemblies 300 are loaded into the terminal cavities 212 in the loading direction, which is generally perpendicular to the screw axis of the screw 350 and/or generally parallel to the power wire 310. In an exemplary embodiment, the terminal retainer 400 is configured to close the load openings 260 after the power terminal assemblies 300 are received in the terminal cavities 212. The terminal retainer 400 is used to retain the power terminal assemblies 300 in the terminal cavities 212.

The terminal retainer 400 is configured to be coupled to the terminal block housing 200 to close access to the terminal cavities 212. The terminal retainer 400 is configured to block removal of the power terminal assemblies 300 from the terminal block housing 200. In an exemplary embodiment, the terminal retainer 400 is integral with the terminal block housing 200. The terminal retainer 400 and the terminal block housing 200 may form a unitary, monolithic structure. For example, the terminal retainer 400 may be co-molded with the terminal block housing 200. In an exemplary embodiment, the terminal retainer 400 is hingedly coupled to the terminal block housing 200 by a hinge 402. For example, the hinge 402 may be a living hinge co-molded with the terminal retainer 400 and the terminal block housing 200. In alternative embodiments, the terminal retainer 400 may be separate and discrete from the terminal block housing 200. For example, the terminal retainer 400 and the terminal block housing 200 may be separately molded pieces, which are coupled together to retain the power terminal assemblies 300 in the terminal cavities 212.

In an exemplary embodiment, the terminal retainer 400 includes a retainer wall 410 having an inner surface 412 and an outer surface 414. The retainer wall 410 may be generally planar. The retainer wall 410 is movable relative to the terminal block housing 200. For example, the retainer wall 410 may be pivoted or rotated between an open position (FIG. 3) and a closed position (FIG. 1). When closed, the inner surface 412 faces the terminal cavities 212 to retain the power terminal assemblies 300 in the terminal cavities 212.

In an exemplary embodiment, the terminal retainer 400 includes securing elements 420 used to secure the retainer wall 410 to the terminal block housing 200. For example, the securing elements 420 may include latching elements, clips, fasteners, or other types of securing elements. The securing elements 420 may be located at opposite sides of the retainer wall 410 and/or at a central location of the retainer wall 410 and/or at other locations. The securing elements 420 are configured to interface with complementary securing elements 262 of the terminal block housing 200 at the rear 226 of the terminal block housing 200. The securing elements 262 may include latching element, clips, fasteners, or other types of securing elements. The securing elements 262 may be located at the sides 230, 232 and/or the separating wall separating wall 214 and/or at other locations.

In an exemplary embodiment, the terminal retainer 400 includes windows 430 through the retainer wall 410. The windows 430 are configured to receive portions of the power terminal assembly 300, such as the tail 324 and/or the power wire 310. The windows 430 are configured to be aligned with the terminal cavities 212. In the illustrated embodiment, the windows 430 are open at an outer edge 432 of the retainer wall 410 to allow loading of the power terminal assembly 300 into the windows 430 as the terminal retainer 400 is moved to the closed position.

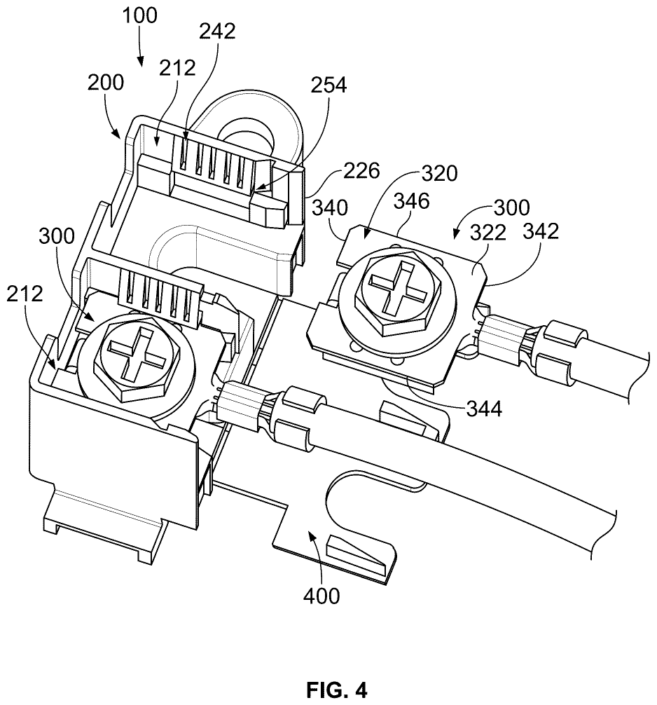

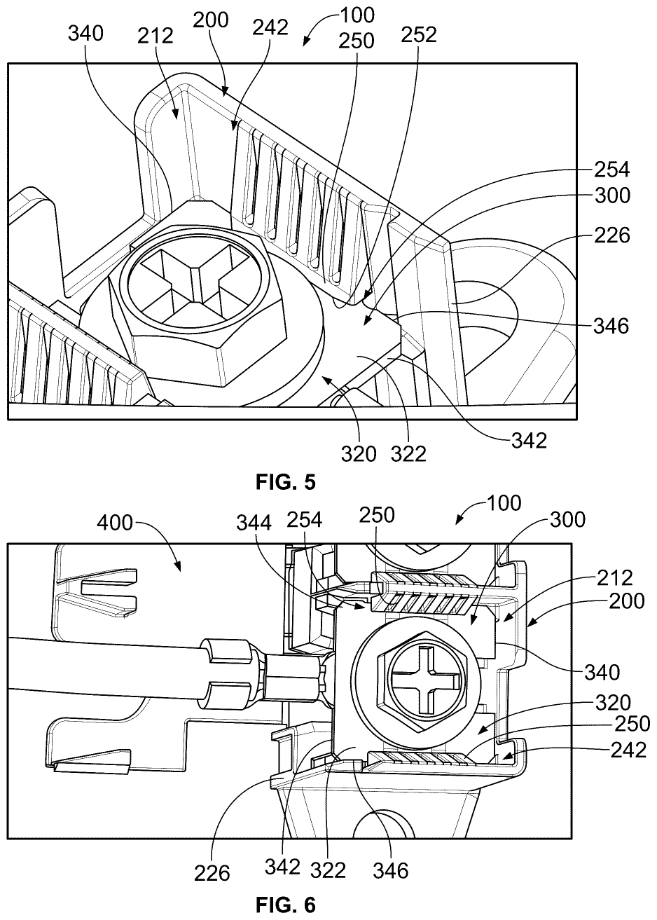

FIG. 4 is a partially assembled view of the power connector 100 in accordance with an exemplary embodiment. FIG. 5 is a rear perspective view of a portion of the power connector 100 in accordance with an exemplary embodiment showing one of the power terminal assemblies 300 loaded into the terminal block housing 200. FIG. 6 is a top perspective view of a portion of the power connector 100 in accordance with an exemplary embodiment showing one of the power terminal assemblies 300 loaded into the terminal block housing 200. FIG. 4 shows one of the power terminal assemblies 300 received in the corresponding terminal cavity 212 and the other power terminal assembly 300 poised for loading into the corresponding terminal cavity 212 in the loading direction, such as the forward loading direction through the rear 226 of the terminal block housing 200.

During assembly, the power terminal assembly 300 is aligned with the terminal cavity 212. For example, the head 322 of the power terminal 320 is aligned with the corresponding slot 254. The head 322 is loaded into the slot 254 between the bottom surfaces 252 of the retainer elements 250 and the support wall 244. The retainer elements 250 engage the first and second side edges 344, 346 of the plate 330 to block upward movement of the power terminal assembly 300 through the access opening 240 to retain the power terminal assembly 300 in the terminal cavity 212. The side walls of the terminal block housing 200 engage the first and second side edges 344, 346 of the plate 330 to block side-to-side movement of the power terminal assembly 300 in the terminal cavity 212. The head 322 may be loaded into the terminal cavity 212 until the front edge 340 engages the front wall at the front 224 of the terminal block housing 200 to block forward movement of the power terminal assemblies 300 in the terminal cavity 212. When the terminal retainer 400 is closed, the terminal retainer 400 is configured to engage the rear edge 342 to block rearward movement of the power terminal assembly 300 and the terminal cavity 212.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

What is claimed is:

1. A power connector comprising:
a terminal block housing including a terminal cavity, the terminal block housing including a top and a bottom extending between a front and a rear of the terminal block housing, the terminal block housing including a first side and a second side between the top and the bottom, the terminal block housing including a load opening at the rear and an access opening at the top;
a power terminal assembly received in the terminal cavity, the power terminal assembly including a power terminal including a head and a tail, the tail configured to be coupled to a power wire, the head including an opening, the power terminal assembly including a screw received in the opening and a nut coupled to a threaded end of the screw configured to be coupled to a ring terminal of a power supply, the head captured between a screw head of the screw and the nut; and
a terminal retainer coupled to the rear of the terminal block housing to close the terminal cavity at the rear;
wherein the power terminal assembly is rear leaded into the terminal cavity through the load opening, the terminal retainer retaining the power terminal assembly in the terminal cavity, the screw head of the screw of the power terminal assembly accessible through the access opening at the top of the terminal block housing.

2. The power connector of claim 1, wherein the terminal retainer is hingedly coupled to the terminal block housing.

3. The power connector of claim 1, wherein the terminal retainer is integral with the terminal block housing forming a unitary monolithic structure.

4. The power connector of claim 1, wherein the terminal retainer includes a retainer wall coupled to the rear of the terminal block housing to block the load opening.

5. The power connector of claim 4, wherein the retainer wall includes a window configured to receive the tail and/or the power wire.

6. The power connector of claim 1, wherein the terminal block housing includes a retainer element extending into the terminal cavity to engage the head to retain the power terminal assembly in the terminal cavity and block removal of the power terminal assembly through the access opening.

7. The power connector of claim 6, wherein the terminal block housing includes a second retainer element, the retainer element and the second retainer element engaging opposite sides of the head.

8. The power connector of claim 6, wherein the terminal block housing includes a support wall, the terminal block housing including a slot between the support wall and the retainer element, the head being received in the slot in a loading direction through the load opening at the rear of the terminal block housing.

9. The power connector of claim 1, wherein the terminal retainer includes a latch being latchably coupled to the terminal block housing.

10. The power connector of claim 1, wherein the screw extends along a screw axis, the power terminal assembly being loaded into the terminal cavity through the load opening in a loading direction perpendicular to the screw axis.

11. The power connector of claim 1, wherein the terminal block housing includes a power supply window configured to receive the ring terminal and/or the power supply.

12. The power connector of claim 1, wherein the head includes a plate including the opening, the plate having a width between first and second side edges and a length between a front edge and a rear edge, the tail extending from the rear edge of the plate.

13. The power connector of claim 12, wherein the width is greater than or equal to the length.

14. The power connector of claim 12, wherein the terminal block housing includes a front wall at the front and side walls on opposite sides of the terminal cavity, the front wall engaging the front edge to block forward movement of the power terminal assembly in the terminal cavity, the terminal retainer engaging the rear edge to block rearward movement of the power terminal assembly in the terminal cavity, the side walls engaging the first and second side edges to block side-to-side movement of the power terminal assembly in the terminal cavity.

15. The power connector of claim 14, wherein the terminal block housing includes retainer elements extending into the terminal cavity, the retainer elements engaging the first and second side edges to block upward movement of the power terminal assembly through the access opening to retain the power terminal assembly.

16. The power connector of claim 1, wherein the terminal block housing includes a second terminal cavity with a separating wall between the terminal cavity and the second terminal cavity, the second terminal cavity receiving a second power terminal assembly, the terminal retainer blocking the second power terminal assembly in the second terminal cavity.

17. A power connector comprising:
a terminal block housing including a terminal cavity, the terminal block housing including a top and a bottom extending between a front and a rear of the terminal block housing, the terminal block housing including a first side and a second side between the top and the bottom, the terminal block housing including a load opening at the rear and an access opening at the top, the terminal block housing including retention elements extending into the terminal cavity;
a power terminal assembly received in the terminal cavity, the power terminal assembly including a power terminal including a head and a tail, the tail configured to be coupled to a power wire, the head including a front edge, a rear edge, a first side edge between the front and rear edges, and a second side edge between the front and rear edges, the head including an opening therethrough, the power terminal assembly including a screw received in the opening and a nut coupled to a threaded end of the screw configured to be coupled to a ring terminal of a power supply, the head captured between a screw head of the screw and the nut, wherein the screw head of the screw of the power terminal assembly is accessible through the access opening at the top of the terminal block housing; and
a terminal retainer coupled to the rear of the terminal block housing to close the terminal cavity at the rear;
wherein the power terminal assembly is rear leaded into the terminal cavity through the load opening, the terminal retainer engaging the rear edge to retain the power terminal assembly in the terminal cavity and block removal of the power terminal assembly through the load opening, and wherein the retention elements engage the first and second side edges to retain the power terminal assembly in the terminal cavity and block removal of the power terminal assembly through the access opening.

18. The power connector of claim 17, wherein the terminal retainer is integral with the terminal block housing forming a unitary monolithic structure, the terminal retainer being hingedly coupled to the terminal block housing by a living hinge.

19. The power connector of claim 17, wherein the terminal block housing includes a support wall, the terminal block housing including a slot between the support wall and the retainer element, the head being received in the slot in a loading direction through the load opening at the rear of the terminal block housing.

20. A terminal block housing for a power terminal assembly including a power terminal including a head holding a screw and a nut configured to be coupled to a ring terminal of a power supply, the terminal block housing comprising:
housing walls forming a terminal cavity, the housing walls extending between a top and a bottom of the terminal block housing, the housing walls extending between a front and a rear of the terminal block housing, the housing walls extending between a first side and a second side of the terminal block housing;
a load opening at the rear providing access to the terminal cavity, wherein the power terminal assembly is configured to be loaded into the terminal cavity through the load opening;
an access opening at the top providing access to the power terminal assembly;
retention elements extending into the terminal cavity, the retention elements are configured to engage the head to retain the power terminal assembly in the terminal cavity and block removal of the power terminal assembly through the access opening; and
a terminal retainer coupled to the rear of the terminal block housing at the load opening to close the terminal cavity at the rear, the terminal retainer configured to engage the head to retain the power terminal assembly in the terminal cavity and block removal of the power terminal assembly through the load opening.
